(19) United States
(12) Patent Application Publication
(10) Pub. No.: US 2017/0288932 A1
(43) Pub. Date: Oct. 5, 2017

(54) CARRIER FREQUENCY OFFSET ESTIMATION IN A RECEIVER

(71) Applicant: QUALCOMM Incorporated, San Diego, CA (US)

(72) Inventors: Eunmo Kang, San Diego, CA (US); Koorosh Akhavan, San Diego, CA (US); Le Nguyen Luong, San Diego, CA (US)

(21) Appl. No.: 15/266,906

(22) Filed: Sep. 15, 2016

Related U.S. Application Data
(60) Provisional application No. 62/314,974, filed on Mar. 29, 2016.

(51) Int. Cl. H04L 27/26; H04L 1/00

(52) U.S. Cl. CPC H04L 27/2672; H04L 1/0018; H04W 4/005

(57) ABSTRACT

Systems and methods are directed to low cost and low power carrier frequency offset (CFO) estimation in a receiver. In-phase (I) and quadrature (Q) samples of a wireless signal are received by the receiver and a first phase and a second phase are extracted from the outputs of a first autocorrelator with a first time-lag and a second autocorrelator with a second time-lag. The extracted first and second phases are combined to generate an estimated CFO of high accuracy and wide estimation range.

### CROSS-REFERENCE TO RELATED APPLICATIONS

The present application for patent claims the benefit of Provisional Patent Application No. 62/314,974 entitled “IN CARRIER FREQUENCY OFFSET ESTIMATION IN A RECEIVER” filed Mar. 29, 2016, pending, and assigned to the assignee hereof and hereby expressly incorporated herein by reference in its entirety.

### FIELD OF DISCLOSURE

Disclosed aspects relate to a receiver of wireless signals. More specifically, exemplary aspects are directed to improvements in carrier frequency offset estimation in the receiver.

### BACKGROUND

Wireless communication systems may include transmitters and receivers (or combinations thereof) of wireless signals. The wireless signals may be transmitted by a transmitter at a carrier frequency controlled by a transmitter-side oscillator (e.g., a crystal oscillator (XO)). Similarly, a receiver-side oscillator may control the frequency at which a receiver operates to receive the wireless signals. Although it is desirable for the transmitter-side oscillator and receiver-side oscillator to be synchronized in frequency, precise synchronization may not be possible due to various operating conditions, manufacturing variations, etc. Accordingly, there may be a mismatch in frequencies, referred to as a carrier frequency offset (CFO), between the transmitter-side and the receiver-side systems.

In an effort to mitigate the adverse effects of the CFO, conventional receivers may include a frequency error estimation block to estimate the CFO, with a view to removing the estimated CFO from a received wireless signal. A known approach to estimating the CFO involves analyzing data packets transmitted in the wireless signals, and more specifically, preambles of the data packets. In several known wireless communication standards, a preamble is typically included at the start of a data packet, wherein the preamble is a known sequence which includes various types of information, such as the symbol timing of the wireless signals and the data packets being transmitted. From the preamble, it is also possible to estimate the CFO using techniques such as autocorrelation of the received wireless signal (e.g., after extracting a phase or sign of the received wireless signals, which can be determined from the known sequence of the preamble).

Conventional techniques for estimating CFO are based on the phase of the output of an autocorrelator, wherein the autocorrelator is configured to compute correlation between input samples separated by a time-lag. It is difficult to select an optimum value for the time-lag because decreasing the time-lag tends to degrade the accuracy of the CFO estimation, whereas increasing the time-lag adversely impacts the range of frequencies for which the CFO estimation is possible. Although some approaches for combating this problem involve using a large number (e.g., four or more) of autocorrelators and combining their outputs for estimating CFO, such approaches tend to be very expensive in terms of area, power consumption, and associated costs, thus rendering them unsuitable for many low cost, low power applications (such as internet-of-things (IoT) applications).

There is a recognized need for accurate CFO estimation techniques for improved performance of the receivers which are suitable for a wide range of frequencies (e.g., to support inter-operation of the receiver with a variety of transmitters, including transmitters which may not conform to established standards, as may be seen in some low cost emerging markets such as the IoT markets). Accordingly, there is a need in the art for low cost and low power CFO estimation techniques in receivers of wireless signals.

### SUMMARY

The following presents a simplified summary relating to one or more aspects disclosed herein. Systems and methods are directed to low cost and low power carrier frequency offset (CFO) estimation in a receiver. In-phase (I) and quadrature (Q) samples of a wireless signal are received by the receiver and a first phase and a second phase are extracted from the outputs of a first autocorrelator with a first time-lag and a second autocorrelator with a second time-lag. The first and second phases are combined to generate an estimated CFO of high accuracy and wide estimation range.

For example, an exemplary aspect is directed to a method for estimating carrier frequency offset (CFO) in a receiver. The method comprises performing a first autocorrelation of received wireless signals in a first autocorrelator with a first time-lag to generate a first autocorrelation signal, wherein the received wireless signals comprise in-phase (I) and quadrature (Q) samples. The method further comprises extracting a first phase of the first autocorrelation signal in a first arctangent block, performing a second autocorrelation of the received wireless signals in a second autocorrelator with a second time-lag to generate a second autocorrelation signal, extracting a second phase of the second autocorrelation signal in a second arctangent block, and combining the first phase and the second phase to generate an estimated CFO.

Another exemplary aspect is directed to an apparatus comprising a receiver configured to receive a wireless signal comprising in-phase (I) and quadrature (Q) samples. The receiver comprises a first autocorrelator with a first time-lag, configured to perform a first autocorrelation of the received wireless signals to generate a first autocorrelation signal and a first arctangent block configured to extract a first phase of the first autocorrelation signal. The receiver further comprises a second autocorrelator with a second time-lag configured to perform a second autocorrelation of the received wireless signals to generate a second autocorrelation signal and a second arctangent block configured to extract a second phase of the second autocorrelation signal. The receiver also comprises a combination block configured to combine the first phase and the second phase to generate an estimated CFO.

Yet another exemplary aspect is directed to an apparatus comprising means for performing a first autocorrelation of received wireless signals with a first time-lag, to generate a first autocorrelation signal, wherein the received wireless signal comprise in-phase (I) and quadrature (Q) samples. The apparatus further comprises means for extracting a first phase of the first autocorrelation signal, means for performing a second autocorrelation of the received wireless signals with a second time-lag, to generate a second autocorrelation signal, means for extracting a second phase of the second autocorrelation signal, and means for combining the first phase and the second phase to generate an estimated CFO.

Another exemplary aspect is directed to a non-transitory computer readable storage medium comprising code, which, when executed by a processor, causes the processor to perform operations for estimating carrier frequency offset (CFO) of received wireless signals. The non-transitory computer readable storage medium comprises code for performing a first autocorrelation of the received wireless signals with a first time-lag, to generate a first autocorrelation signal, wherein the received wireless signals comprise in-phase (I) and quadrature (Q) samples, code for extracting a first phase of the first autocorrelation signal, code for performing a second autocorrelation of the received wireless signals with a second time-lag, to generate a second autocorrelation signal, code for extracting a second phase of the second autocorrelation signal, and code for combining the first phase and the second phase to generate an estimated CFO.

### BRIEF DESCRIPTION OF THE DRAWINGS

The accompanying drawings are presented to aid in the description of aspects of the invention and are provided solely for illustration of the aspects and not limitation thereof.

FIG. 1 illustrates a conventional receiver system for carrier frequency offset (CFO) estimation with a single autocorrelator.

FIG. 2 illustrates another conventional receiver system for CFO estimation with four autocorrelators.

FIG. 3 illustrates an exemplary receiver system for CFO estimation with two autocorrelators.

FIG. 4 an exemplary receiver system with a third autocorrelator cascaded to the receiver system of FIG. 3.

FIG. 5 illustrates an example graph of phase error correction, according to aspects of the disclosure.

FIG. 6 illustrates an example wireless transceiver with receiver-side processing, according to aspects of the disclosure.

FIG. 7 illustrates example wireless devices, according to aspects of the disclosure.

FIG. 8 illustrates an example process for carrier frequency offset estimation, according to aspects of the disclosure.

### DETAILED DESCRIPTION

Various aspects are disclosed in the following description and related drawings directed to specific aspects of the invention. Alternate aspects may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any aspect described herein as “exemplary” is not necessarily to be construed as preferred or advantageous over other aspects. Likewise, the term “aspects of the invention” does not require that all aspects of the invention include the discussed feature, advantage or mode of operation.

The terminology used herein is for the purpose of describing particular aspects only and is not intended to be limiting of aspects of the invention. As used herein, the singular forms “a”, “an”, and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of non-transitory computer-readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter.

Exemplary aspects of this disclosure are directed to carrier frequency offset (CFO) estimation in a receiver of wireless signals. In an aspect, a high accuracy CFO estimation is achieved for a wide range of frequencies (also referred to as a wide estimation range), by using two autocorrelators with different time-lags, wherein a time-lag is denoted as “L” herein. The outputs computed by the two autocorrelators (referred to as “angles”) are combined in exemplary aspects for estimating the CFO of the received signal. As will be explained in further detail below, the exemplary techniques avoid the aforementioned drawbacks of conventional techniques.

By way of background, an example receiver of wireless signals in this disclosure may be configured to receive signals from transmitter which modulates data signals for transmission on to a carrier wave. The receiver may receive the modulated signals and demodulate the data signals. Various types of modulation techniques are known in the art, such as phase modulation, amplitude modulation, etc. In this disclosure, phase modulation is considered in more detail. Phase modulation refers to a type of modulation where data signals (or information) are digitally encoded as variations in an instantaneous phase of the carrier wave. In the context of digital signal transmission, phase modulation is seen to switch between different phases. Thus, phase modulation is generally referred to as phase shift keying (PSK). Numerous types of PSK are known in the art, such as, quadrature PSK (QPSK), offset-QPSK (O-QPSK), binary PSK (BPSK), minimum shift keying (MSK), etc., wherein it may also be possible to switch between different types of PSK based on particular system configurations and requirements.

For example, considering a QPSK modulator in a transmitter, an input bit stream of the data signals to be transmitted is split into in-phase (I) and quadrature (Q) waveforms, which are then separately modulated by two carriers which are in phase quadrature (e.g., a sine and a cosine carrier wave which are varied in phase, while keeping amplitude and frequency constant). This allows transmission of two bits in each modulation symbol, with four possible different symbols since the phase of the carrier wave can take on four possible values (e.g., 0, π/2, π, 3π/2), wherein each phase corresponds to a different symbol. An O-QPSK modulator is similar to the QPSK modulator and O-QPSK signals may be obtained by generating the I and Q waveforms similar to the QPSK case but passed through half-sine (HS) shaping filters, and shifting the Q waveform by half a symbol period with respect to the I waveform. In either form of modulation, on the receiver side, the received wireless signals comprise the modulated I and Q components. Further processing of the received wireless signals will now be discussed below.

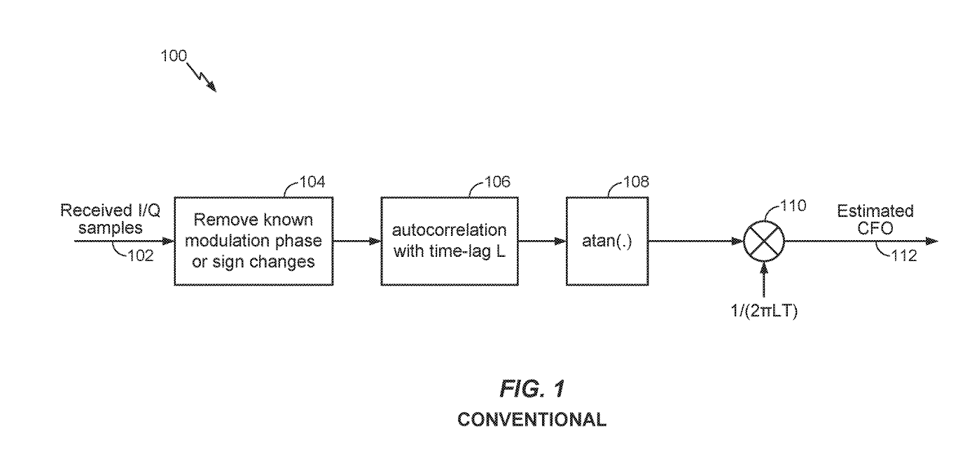

With reference to FIG. 1 a conventional approach for CFO estimation is illustrated for the case of a conventional receiver 100. In-phase (I) and quadrature (Q) samples of wireless signals received by receiver 100 are provided as inputs denoted by received I/Q samples 102. Block 104 is configured to remove the known modulation phase or sign changes of received I/Q samples 102 and the output of block 104 is provided to autocorrelation block 106. Autocorrelation block 106 is configured to detect the correlation between I/Q samples 102 separated by a time-lag L and arctangent (a tan(.) block 108 is configured to compute the phase of the complex-valued autocorrelation signal. The output of the arctangent block 108 is scaled by 1/(2πLT) to convert the output of block 108 to the estimated CFO 112. As previously mentioned, if time-lag L is small, then the accuracy of CFO estimation is low, but if time-lag L is large, then the estimation range is narrow, because the phase of the autocorrelator output 2πf_{CFO}LT (where T denotes the sample period in seconds) can go past a [−π, π) range, which can lead to a phase aliasing phenomenon wherein the phase may wrap around and appear as an incorrect value which falls within the estimation range. Phase aliasing can occur even for a relatively small CFO if a large value is selected for time-lag L to achieve high accuracy. Therefore, the design of receiver 100 is not suitable for a high estimation range.

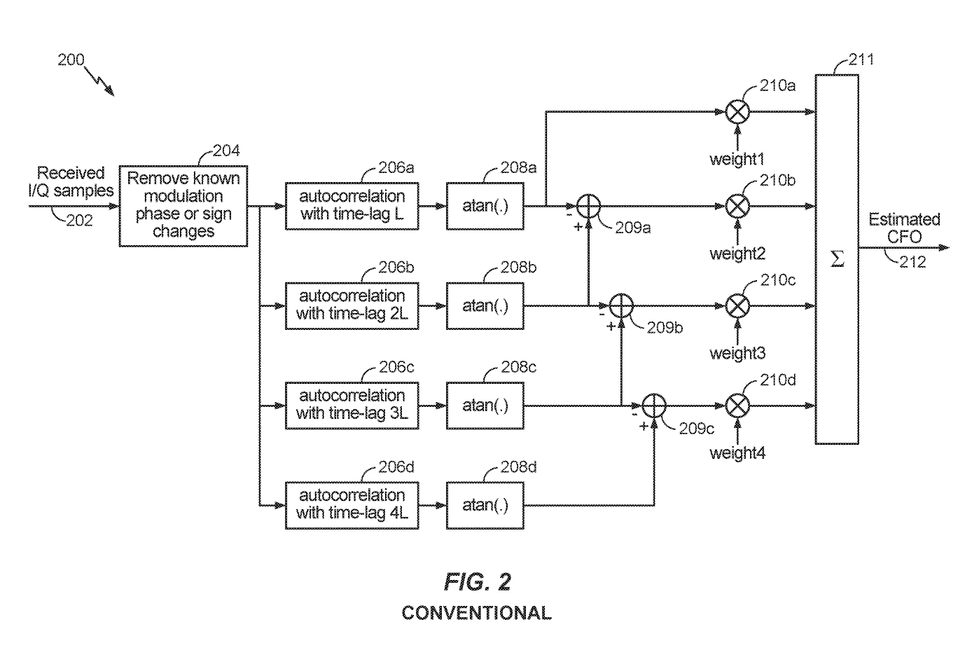

Referring now to FIG. 2, another conventional approach for CFO estimation is shown for the case of another conventional receiver 200. Compared to receiver 100, receiver 200 is designed with a view to improving accuracy and increasing the estimation range, but as will be explained further, at the cost of increased area and power consumption. In more detail, similar to receiver 100, receiver 200 also receives I/Q input samples 202 and removes known modulation phase or sign changes in block 204. However, unlike receiver 100, receiver 200 includes four autocorrelators, each with a different time-lag. As shown, autocorrelator 206a operates with a first time-lag L (i.e., is configured to detect the correlation between I/Q samples 202 separated by a time-lag L); autocorrelator 206b operates with a time-lag two times the first time lag or 2L (i.e., is configured to detect the correlation between I/Q samples 202 separated by a time-lag 2L); autocorrelator 206c operates with a time-lag three times the first time lag or 3L (i.e., is configured to detect the correlation between I/Q samples 202 separated by a time-lag 3L); and autocorrelator 206d operates with a time-lag four times the first time lag or 4L (i.e., is configured to detect the correlation between I/Q samples 202 separated by a time-lag 4L).

In the implementation shown, outputs from these four autocorrelators 206a-d are passed through four arctangent blocks 208a-d, respectively, and each real-valued output of arctangent blocks 208a-c are subtracted from subsequent real-valued output of arctangent blocks 208b-d as shown, in a pair-wise manner in adders 209a-c (configured as subtractors) as shown (e.g., output of arctangent block 208a is subtracted from output of arctangent blocks 208b in adder 209a to generate a first difference; output of arctangent block 208b is subtracted from output of arctangent blocks 208c in adder 209b to generate a second difference; and output of arctangent block 208c is subtracted from output of arctangent block 208d in adder 209c to generate a third difference). The output of arctangent block 208a and outputs of adders 209a-c (the first, second, and third differences, respectively) are respectively scaled in multipliers 210a-d by respective weights, weight1-weight4, and finally summed in the multi-input summation block shown as adder 211 to produce the estimated CFO 212. As can be appreciated, the four autocorrelators 206a-d, four arctangent blocks 208a-d, three adders 209a-c, four multipliers 210a-d, and adder 211 incur significant area, power consumption and associated costs.

Although not discussed in detail, other conventional designs of receivers known in the art may include additional components for CFO estimation, such as autocorrelators with time-lags up to 16L along with corresponding accompanying blocks such as arctangent blocks, adders, etc., in an effort to further improve accuracy, but as can be appreciated, the area and power costs for such designs are even higher.

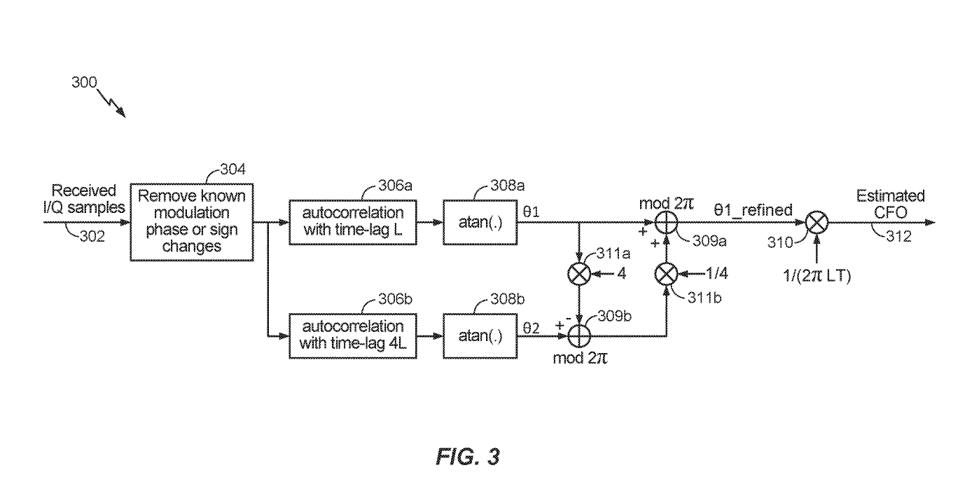

With reference to FIG. 3, receiver 300, designed according to exemplary aspects for achieving CFO estimation with high accuracy is illustrated. Receiver 300 is configured for a wide estimation range but avoids the increased costs seen in the conventional design discussed above with reference to FIG. 2.

As shown in FIG. 3, receiver 300 includes only two autocorrelators with different time-lags. Before explaining the components of receiver 300 in more detail, the functionality of CFO estimation in receiver 300 will be briefly explained first. It is recognized that although an autocorrelator with a first time-lag L has a low-accuracy, a wide-range phase estimate corresponding to the time-lag L can be warped to a magnified phase domain to obtain the phase error of the auto-correlator. The phase error computation is aided by a high-accuracy but narrow-range phase estimate corresponding to an autocorrelator with time-lag four times the first time lag or 4L. The phase error obtained in the magnified phase domain is then shrunk back to the original phase domain, and is used to correct the original phase, thereby achieving an overall high accuracy of the CFO estimation.

With the above functionality in mind, and with continuing reference to FIG. 3, the illustrated configuration of receiver 300 will now be explained in further detail. As shown, receiver 300 receives I/Q samples 302 of a received wireless signal and block 304 is configured to remove known modulation phase or sign changes from the I/Q samples. The output of block 304 is fed to two autocorrelators 306a and 306b to generate a first autocorrelation signal and a second autocorrelation signal. In the implementation shown, autocorrelator 306a is configured with a time-lag L whereas autocorrelator 306b is configured with a time-lag 4L (although it will be understood that other implementations of receiver 300 with two autocorrelators but with different time-lags is possible within the scope of this disclosure).

The first and second autocorrelation signals at the outputs of autocorrelators 306a-b are provided to arctangent blocks 308a-b, to extract a first phase of the first autocorrelation signal (shown as θ1) and a second phase of the second autocorrelation signal (shown as θ2), respectively. The first phase and the second phase are then combined in the following manner: the first phase is scaled up by multiplier 311a (e.g., multiplied by a factor of 4 in the implementation shown, to obtain a phase estimate in the magnified phase domain corresponding to the phase of autocorrelator 308a with time-lag L) to generate a scaled first phase; a difference between the scaled first phase and the second phase is computed in a first adder shown as adder 309b (wherein the “adder” can also perform subtraction); the difference obtained from adder 309b is scaled down or shrunk (e.g., divided by a factor of 4) in a first multiplier shown as multiplier 311b to obtain a scaled difference (back in the original phase domain); the scaled difference is then added with the first phase in a second adder shown as adder 309a to obtain a refined first phase (θ1_refined) in the original phase domain; and the refined first phase is scaled in a second multiplier shown as multiplier 310 by 1/(2πLT) to generate estimated CFO 312 with a high accuracy and wide estimation range, wherein the “mod 2π” notation shown for adders 309a-b refers to a modulo-2π operation, which adds 2π to or subtracts 2π from the outputs of these adders until the respective adders' outputs fall in the range between −π and π. The combination of adders 309a-b, multipliers 311a-b, and multiplier 310 used in the above combining of the first and second phases may also be collectively referred to as a combination block in the description below. Since only two autocorrelators are used in the design of receiver 300, there is a significant power and area savings. It will also be understood that the scaling factors of 4 and ¼ are merely examples, and other scaling factors, e.g., 4 and 0.2, may also be used in multipliers 311a-b in order to assign different weighing factors to θ1 and θ2 for generating the refined first phase.

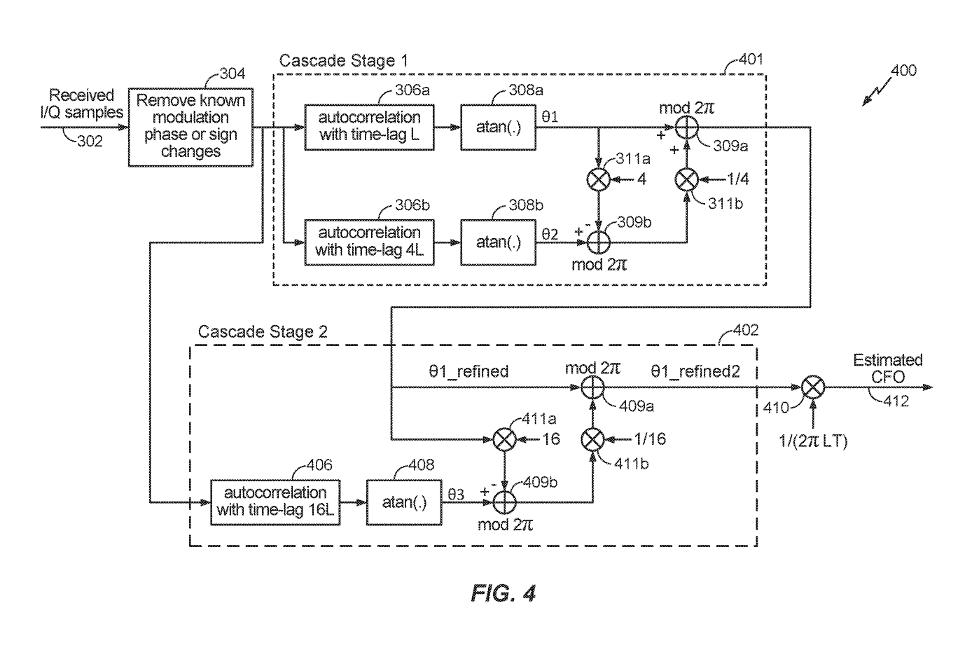

In some aspects, it is possible to further improve the accuracy by cascading the CFO estimation as discussed with reference to receiver 300 with one or more additional stages of autocorrelation to obtain a combined CFO estimate with greater accuracy, e.g., cascading with autocorrelators with even bigger time-lags, such as sixteen times the first time lag or 16L, as shown and discussed with reference to FIG. 4 below.

With reference to FIG. 4, receiver 400 is shown, with the above-described blocks 306a-b, 308a-b, 309a-b, and 311a-b of receiver 300 illustrated as forming first cascade stage 401. The outputs of block 304 and refined first phase (θ1_refined) from FIG. 3 are also provided to a cascaded second stage shown as second cascade stage 402. Considering second cascade stage 402 in greater detail, autocorrelator 406 is provided therein, with time-lag sixteen times L or 16L, whose output is supplied to arctangent block 408 to extract a third phase (shown as θ3). The refined first phase, θ1_refined is scaled up or magnified (e.g., multiplied by a factor of 16) in multiplier 411a to obtain a scaled refined first phase, which is subtracted from the third phase in adder 409b to obtain a difference. The difference is scaled down or shrunk (e.g., divided by a factor of 16) in multiplier 411b to obtain a scaled difference, which is added with the refined first phase in adder 409a to obtain a further refined first phase (shown as θ1_refined2). The further refined first phase may then be scaled by 1/(2πLT) in multiplier 410 to generate a combined CFO estimate 412, which is an even more accurate estimated CFO. In this manner, any number of cascading stages can be added depending on the desired accuracy, while balancing considerations of area, power consumption, and cost.

Although the present disclosure is not limited to any one or more specific wireless communication standards or protocols, an exposition of the principles related to CFO estimation in exemplary aspects will be discussed with relation to an example standard. Specifically, a wireless signal received with an offset quadrature phase shift keying (O-QPSK) modulation as discussed above will be considered. The difference between modulation techniques such as O-QPSK and minimum shift keying (MSK), for example, lies in the way the input bits are mapped, and so below explanation for O-QPSK signals may also be applicable for other types of modulation, such as MSK.

In an exemplary receiver (e.g., receiver 300 or 400) which receives wireless signals modulated as O-QPSK signals, for example, in the absence of channel phase information and where a CFO is present, a differential matched filter implementation may be selected in an acquisition block, which typically includes a CFO estimation block, of the exemplary receiver. The differential matched filter implementation operates based on the phase difference between adjacent chips. For notational simplicity, an input sample rate of the received signal is assumed to be the chip rate (e.g., 2 MHz) of the received signals (contribution due to noise is omitted for the sake of simplicity). The symbols T_{c}, f₀, and θ₀ represent the chip duration, CFO, and the initial channel phase, respectively. A complex-valued input sample at time index n can be represented by

r[n]=e^{j(2πf}^{₀}^{nT}^{_{c}}^{+θ}^{₀}^{+φ[n])} (Equation 1)

wherein φ[n] denotes the cumulative phase sequence as

$$φ [ 𝓁 ] = \frac{π}{2} {\sum }_{{𝓁}^{′} = 0}^{𝓁} m [ {𝓁}^{′} ] \qquad ( Equation 2 )$$

wherein, in Equation 2, m[n] denotes the MSK chip value at chip index n, which is 1 if r[n] has 90 degrees higher phase than r[n−1] when the input sequence r[n] is on time, and −1 if r[n] has 90 degrees lower phase than r[n−1].

The differential matched filter output f[n] can be represented as

f[n]=Σₗ₌₁^{N}Im[r[n−N+l−1]*r[n−N+l]]m[n−N+l] (Equation 3)

where N denotes the matched filter length in chips, Equation 3 can be expressed differently as

$$f [ n ] = {\sum }_{𝓁 = 1}^{N} Re [ {r [ n - N + 𝓁 - 1 ]}^{*} r [ n - N + 𝓁 ] {e}^{- j \frac{π}{2} m [ n - N + 𝓁 ]} ] \qquad ( Equation 4 )$$

It is possible and more convenient to remove the phase sequence introduced by the modulator from r[n]. The decorrelated sample is denoted as c[n; l], which is related to r[n] as:

c[n;l]=r[n−N+l]e^{-jφ[n-N+l]} (Equation 5)

From Equations 1 and 5, the decorrelated sample at on-time, i.e., n=N, which corresponds to the output of block 304 in FIGS. 3-4 for removing known modulation phase or sign changes is represented as follows:

c[N;l]=r[l]e^{-jφ[l]}=e^{j(2πf}^{₀}^{lT}^{_{c}}^{+θ}^{₀}⁾ (Equation 6)

Hence, in estimating the CFO, the output of block 306a of FIGS. 3-4 the autocorrelation with time-lag L is provided by the following equations:

g(L)=Σ_{l=L}^{N}c[N;l−L]*c[N;l] (Equation 7)

at n=N, which can be reduced to

g(L)=Σ_{l=L}^{N}e^{j2πf}^{₀}^{LT}^{_{c}}=(N−L+1)e^{j2πf}^{₀}^{LT}^{_{c}} (Equation 8)

From Equation 8, the following observations can be made. First, assuming the accuracy of phase estimation (for 2πf₀LT_{c}) is identical for different values of L, CFO can be estimated more accurately for bigger L because CFO is proportional to the estimated phase divided by L. Second, if L is too large, the phase will become larger than π, or smaller than −π, causing ambiguity in CFO. For example, with 200 kHz CFO, the phase 2πf₀LT_{c} is 36 degrees for L=1, and 144 degrees for L=4, for which CFO can be estimated without ambiguity. However, with L=5 (or higher), the phase becomes 180 degrees (or higher), hence it may not be possible to distinguish +200 kHz and −200 kHz CFO (or other CFO pairs).

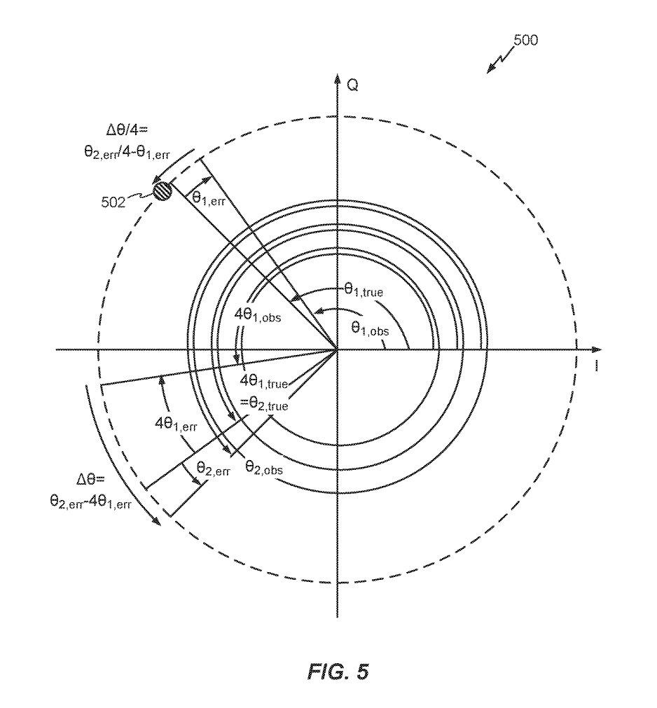

With reference now to FIG. 5, phase graph 500 is shown for I/Q samples (e.g., 302 of FIG. 3) of a received signal, based on which the following illustrative example will now be described. FIG. 5 illustrates an exemplary technique for combining more than one g(L) metrics in order to improve the accuracy of CFO estimation, e.g., combining two metrics, g(4) and g(16). In the illustration, CFO is assumed to be 190 kHz, which results in the following values: the observed phase of g(4) is θ_{1,obs}=136.8°+θ_{1,err} and that of g(16) is θ_{2,obs}=547.2°+θ_{2,err}=−172.8°+θ_{2,err}, where the phase estimation errors are assumed to be θ_{1,err}=−1° and θ_{2,err}=1°.

Since θ_{1,obs}=135.8°, θ₂ is seen to be around 4θ_{1,obs}=4×135.8°=543.2°. Hence, the observed θ_{2,obs}=−171.8° is seen to be in fact −171.8°+2×360°=548.2°. However, this algorithm does not need to detect how many 360° rotations are present in θ_{2,obs}, due to the modulo 2π operation, wherein, once again, the “modulo 2π” operation refers to adding 2π or subtracting 2π from the input value until it falls in the range between −π and π. Accordingly, phase error can be calculated as Δθ=θ_{2,obs}−4θ_{1,obs} mod 2π=5°. This leads to obtaining the adjusted phase (point 502 in FIG. 5) as

$${θ}_{1 , obs} + \frac{Δθ}{4} = 135.8 ° + 1.25 ° ,$$

which is only 0.25°=θ_{2,err}/4 higher than the true phase.

The above illustrative example will now be recast into general mathematical expressions, as follows. With the phase of g(L₁) and g(L₂) denoted by the previously discussed first and second phases, θ₁ and θ₂, respectively, the estimated CFO (e.g., 312 in FIG. 3) can be mathematically described as

f_{0,est}=f₁+f_{1,err}, (Equation 9)

where f₁ represents the CFO estimate solely based on g(L₁) as

$${f}_{1} = \frac{{θ}_{1}}{2 π {L}_{1} {T}_{c}} \qquad ( Equation 10 )$$

and f_{1,err} represents the frequency error calculated from the corresponding phase error as

$${f}_{1 , err} = \frac{{Δθ}_{shrunk}}{2 π {L}_{2} {T}_{c}} . \qquad ( Equation 11 )$$

The shrunk phase error (e.g., at the output of multiplier 311b in FIG. 3) is obtained from the magnified phase error (e.g., at the output of adder 309b in FIG. 3), denoted as Δθ, and defined as

Δθ=(θ₂−Mθ₁)mod 2π (Equation 12)

using the following relationship

$${Δθ}_{shrunk} = \frac{Δθ}{M} , \qquad ( Equation 13 )$$

wherein, in Equation 13, M=L₂/L₁ denotes the magnification ratio.

Referring back to FIG. 4, the higher accuracy discussed therein, can be achieved by cascading the above algorithm. In this case, another metric g(L₃) is computed with a bigger spacing L₃ than L₂, and the above-discussed procedure is repeated using the further refined first phase θ′₁=θ₁+Δθₛₕᵣᵤₙₖ obtained above, and the third phase θ₃ obtained from the third metric g(L₃).

Accordingly, it is seen that the exemplary CFO estimation techniques (e.g., in receiver 300 with two autocorrelators 306a-b designed with time-lags L and 4L, as well as in the cascaded receiver 400), the estimated CFO has a high accuracy, but is provided at a low cost and applicable to a wide estimation range.

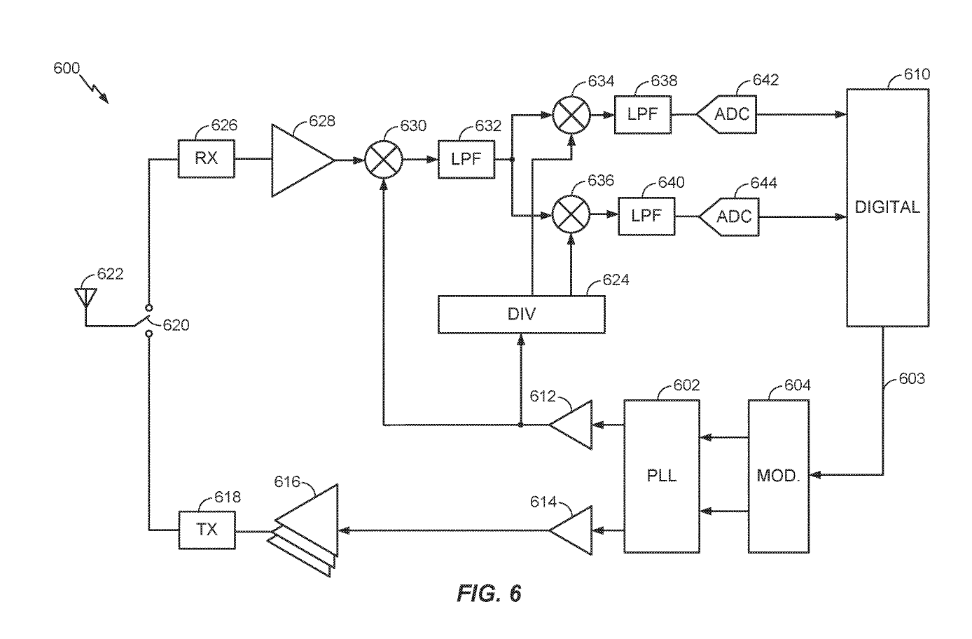

With reference now to FIG. 6 an example wireless transceiver 600 according to aspects of the disclosure is shown. The illustrated example of wireless transceiver 600 includes PLL 602, modulator 604, digital controller 610, buffers 612 and 614, transmit amplifiers 616, transmit matching network 618, transmit/receive switch 620, antenna 622, divider 624, receive matching network 626, front end amplifier 628, mixer 630, low pass filter 632, mixers 634 and 636, low pass filters 638 and 640, and analog-to-digital converters (ADCs) 642 and 644. Wireless transceiver 600 is illustrated as having distinct transmit and receive processing paths. Exemplary aspects of this disclosure may be applicable to the receive processing path, as discussed in the above sections.

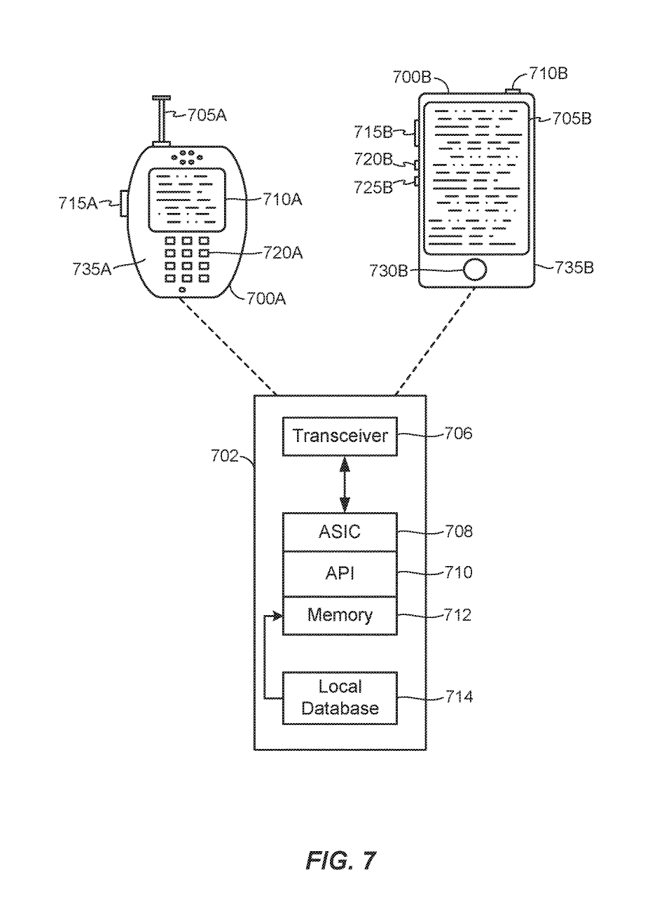

With reference now to FIG. 7, example wireless devices 700A and 700B, according to aspects of the disclosure are illustrated. In some examples, wireless devices 700A and 700B may herein be referred to as wireless mobile stations. The example wireless device 700A is illustrated in FIG. 7 as a calling telephone and wireless device 700B is illustrated as a touchscreen device (e.g., a smart phone, a tablet computer, etc.). As shown in FIG. 7, an exterior housing 735A of wireless device 700A is configured with antenna 705A, display 710A, at least one button 715A (e.g., a PTT button, a power button, a volume control button, etc.) and keypad 720A among other components, not shown in FIG. 7 for clarity. An exterior housing 735B of wireless device 700B is configured with touchscreen display 705B, peripheral buttons 710B, 715B, 720B and 725B (e.g., a power control button, a volume or vibrate control button, an airplane mode toggle button, etc.), at least one front-panel button 730B (e.g., a Home button, etc.), among other components, not shown in FIG. 7 for clarity. For example, while not shown explicitly as part of wireless device 700B, wireless device 700B may include one or more external antennas and/or one or more integrated antennas that are built into the exterior housing 735B of wireless device 700B, including but not limited to WiFi antennas, cellular antennas, satellite position system (SPS) antennas (e.g., global positioning system (GPS) antennas), and so on.

While internal components of wireless devices such as the wireless devices 700A and 700B can be embodied with different hardware configurations, a basic high-level configuration for internal hardware components is shown as platform 702 in FIG. 7. Platform 702 can receive and execute software applications, data and/or commands transmitted from a radio access network (RAN) that may ultimately come from a core network, the Internet and/or other remote servers and networks (e.g., an application server, web URLs, etc.). Platform 702 can also independently execute locally stored applications without RAN interaction. Platform 702 can include a transceiver 706 operably coupled to an application specific integrated circuit (ASIC) 708, or other processor, microprocessor, logic circuit, or other data processing device. ASIC 708 or other processor executes an application programming interface (API) 710 layer that interfaces with any resident programs in a memory 712 of the electronic device. Memory 712 can be comprised of read-only or random-access memory (RAM and ROM), EEPROM, flash cards, or any memory common to computer platforms. Platform 702 also can include a local database 714 that can store applications not actively used in memory 712, as well as other data. Local database 714 is typically a flash memory cell, but can be any secondary storage device as known in the art, such as magnetic media, EEPROM, optical media, tape, soft or hard disk, or the like.

In one aspect, wireless communications by wireless devices 700A and 700B may be enabled by the transceiver 706 based on different technologies, such as CDMA, W-CDMA, time division multiple access (TDMA), frequency division multiple access (FDMA), Orthogonal Frequency Division Multiplexing (OFDM), GSM, 2G, 3G, 4G, LTE, or other protocols that may be used in a wireless communications network or a data communications network. Voice transmission and/or data can be transmitted to the electronic devices from a RAN using a variety of networks and configurations. Accordingly, the illustrations provided herein are not intended to limit the aspects of the invention and are merely to aid in the description of aspects of aspects of the invention.

Accordingly, aspects of the present disclosure can include a wireless device (e.g., wireless devices 700A, 700B, etc.) configured, and including the ability to perform the functions as described herein. For example, transceiver 706 may be implemented as wireless transceiver 600 of FIG. 6, including the receive-processing path. As will be appreciated by those skilled in the art, the various logic elements can be embodied in discrete elements, software modules executed on a processor or any combination of software and hardware to achieve the functionality disclosed herein. For example, ASIC 708, memory 712, API 710 and local database 714 may all be used cooperatively to load, store and execute the various functions disclosed herein and thus the logic to perform these functions may be distributed over various elements. Alternatively, the functionality could be incorporated into one discrete component. Therefore, the features of the wireless devices 700A and 700B in FIG. 7 are to be considered merely illustrative and the invention is not limited to the illustrated features or arrangement.

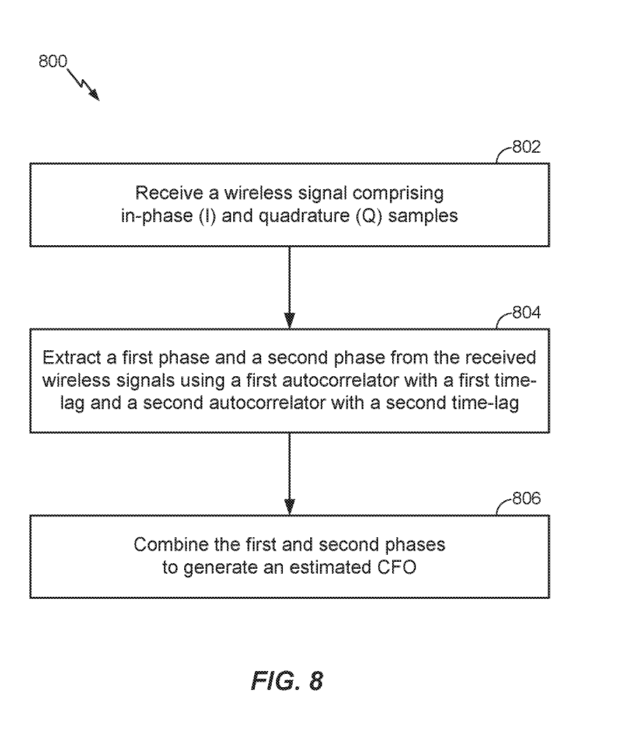

FIG. 8 illustrates an example method (800) for estimating carrier frequency offset (CFO) in a receiver (e.g., 300), the method comprising: receiving a wireless signal comprising in-phase (I) and quadrature (Q) samples (e.g. 302)—Block 802; extracting a first phase (e.g., θ1) and a second phase (e.g., θ2) from the I and Q samples, in a first autocorrelator with a first time-lag (e.g., 306a) and a second autocorrelator with a second time-lag (e.g., 306b)—Block 804; and combining the first and second phases to generate an estimated CFO (e.g., 312)—Block 806. As described above, the above combination in Block 806 can comprise scaling the first phase (e.g., in multiplier 311a), computing a difference between the scaled first phase and the second phase (e.g., in adder 309b), scaling the difference (e.g., in multiplier 311b), and adding the scaled difference to the first phase (e.g., in adder 309a) to obtain a refined first phase (e.g., θ1_refined) in the original phase domain.

Furthermore, method 800 can comprise passing the refined first phase through multiplier 310, which scales the refined first phase by 1/(2πLT) to generate estimated CFO 312 with a high accuracy and wide estimation range.

In some examples (e.g., receiver 400 designed with first and second cascading stages 401 and 402), method 800 can further comprise providing the refined first phase (e.g., θ1_refined) to the second cascading stage to obtain a combined CFO estimate, e.g., estimated CFO 412 of greater accuracy than the estimated CFO 312, for example. As shown in FIG. 4, the second cascading stage may comprise a third autocorrelator (e.g., autocorrelator 406 with a third time lag 16L) and a phase extractor (e.g., arctangent block 408).

Further, those of skill in the art will appreciate that the various illustrative logical blocks, modules, circuits, and algorithm steps described in connection with the aspects disclosed herein may be implemented as electronic hardware or a combination of computer software and electronic hardware. To clearly illustrate this interchangeability of hardware and hardware-software combinations, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the invention can include a non-transitory computer-readable media embodying a method for estimating carrier frequency offset (CFO) in a receiver. Accordingly, the invention is not limited to illustrated examples and any means for performing the functionality described herein are included in aspects of the invention.

While the foregoing disclosure shows illustrative aspects of the invention, it should be noted that various changes and modifications could be made herein without departing from the scope of the invention as defined by the appended claims. The functions, steps and/or actions of the method claims in accordance with the aspects of the invention described herein need not be performed in any particular order. Furthermore, although elements of the invention may be described or claimed in the singular, the plural is contemplated unless limitation to the singular is explicitly stated.

What is claimed is:

1. A method for estimating carrier frequency offset (CFO) in a receiver, the method comprising:
performing a first autocorrelation of received wireless signals in a first autocorrelator with a first time-lag to generate a first autocorrelation signal, wherein the received wireless signals comprise in-phase (I) and quadrature (Q) samples;
extracting a first phase of the first autocorrelation signal in a first arctangent block;
performing a second autocorrelation of the received wireless signals in a second autocorrelator with a second time-lag to generate a second autocorrelation signal;
extracting a second phase of the second autocorrelation signal in a second arctangent block; and
combining the first phase and the second phase to generate an estimated CFO.

2. The method of claim 1, wherein combining the first phase and the second comprises:
scaling the first phase;
computing a difference between the scaled first phase and the second phase;
scaling the difference;
adding the scaled difference to the first phase to generate a refined first phase; and
scaling the refined first phase to generate the estimated CFO.

3. The method of claim 2, wherein scaling the first phase comprises magnifying the first phase wherein scaling the difference comprises shrinking the difference.

4. The method of claim 3, wherein the second time-lag is four times the first time-lag, the magnifying is by a factor of four, and the shrinking is by a factor of four.

5. The method of claim 2, further comprising combining the refined first phase with a third phase generated by a third autocorrelator with a third time-lag, to generate a combined CFO estimate.

6. The method of claim 5, wherein the third time-lag is sixteen times the first time-lag and the second time-lag is four times the first time-lag.

7. An apparatus comprising:
a receiver configured to receive a wireless signal comprising in-phase (I) and quadrature (Q) samples, the receiver further comprising:
a first autocorrelator with a first time-lag, configured to perform a first autocorrelation of the received wireless signals to generate a first autocorrelation signal;
a first arctangent block configured to extract a first phase of the first autocorrelation signal;
a second autocorrelator with a second time-lag configured to perform a second autocorrelation of the received wireless signals to generate a second autocorrelation signal;
a second arctangent block configured to extract a second phase of the second autocorrelation signal; and
a combination block configured to combine the first phase and the second phase to generate an estimated CFO.

8. The apparatus of claim 7, wherein the combination block comprises:
a first multiplier configured to scale the first phase;
a first adder configured to compute a difference between the scaled first phase and the second phase;
a second multiplier configured to scale the difference;
a second adder configured to add the scaled difference to the first phase to generate a refined first phase; and
a multiplier configured to scale the refined first phase to generate the estimated CFO.

9. The apparatus of claim 8, wherein the first multiplier is configured to magnify the first phase and the second multiplier is configured to shrink the difference.

10. The apparatus of claim 9, wherein the second time-lag is four times the first time-lag, the first multiplier is configured to magnify by a factor of four, and the second multiplier is configured to shrink is by a factor of four.

11. The apparatus of claim 8, further comprising a cascaded second stage comprising a third autocorrelator with a third time-lag to perform a third autocorrelation of the received wireless signals to generate a third autocorrelation signal and a third arctangent block to extract a third phase from the third autocorrelation signal, wherein the third phase is combined with the refined first phase to generate a combined CFO estimate.

12. The apparatus of claim 11, wherein the third time-lag is sixteen times the first time-lag and the second time-lag is four times the first time-lag.

13. An apparatus comprising:
means for performing a first autocorrelation of received wireless signals with a first time-lag, to generate a first autocorrelation signal, wherein the received wireless signals comprise in-phase (I) and quadrature (Q) samples;
means for extracting a first phase of the first autocorrelation signal;
means for performing a second autocorrelation of the received wireless signals with a second time-lag, to generate a second autocorrelation signal;
means for extracting a second phase of the second autocorrelation signal; and
means for combining the first phase and the second phase to generate an estimated CFO.

14. The apparatus of claim 13, further comprising:
means for scaling the first phase;
means for computing a difference between the scaled first phase and the second phase;
means for scaling the difference;
means for adding the scaled difference to the first phase to generate a refined first phase; and
means for scaling the refined first phase to generate the estimated CFO.

15. The apparatus of claim 14, wherein scaling the first phase comprises magnifying the first phase wherein scaling the difference comprises shrinking the difference.

16. The apparatus of claim 15, wherein the second time-lag is four times the first time-lag, the magnifying is by a factor of four, and the shrinking is by a factor of four.

17. The apparatus of claim 13, further comprising means for combining the refined first phase with a third phase generated with a third time-lag, to generate a combined CFO estimate.

18. The apparatus of claim 17, wherein the third time-lag is sixteen times the first time-lag and the second time-lag is four times the first time-lag.

19. A non-transitory computer readable storage medium comprising code, which, when executed by a processor, causes the processor to perform operations for estimating carrier frequency offset (CFO) of received wireless signals, the non-transitory computer readable storage medium comprising:
code for performing a first autocorrelation of the received wireless signals with a first time-lag, to generate a first autocorrelation signal, wherein the received wireless signals comprise in-phase (I) and quadrature (Q) samples;
code for extracting a first phase of the first autocorrelation signal;
code for performing a second autocorrelation of the received wireless signals with a second time-lag, to generate a second autocorrelation signal;
code for extracting a second phase of the second autocorrelation signal; and
code for combining the first phase and the second phase to generate an estimated CFO.

20. The non-transitory computer readable storage medium of claim 19, wherein code for combining the first phase and the second comprises:
code for scaling the first phase;
code for computing a difference between the scaled first phase and the second phase;
code for scaling the difference;
code for adding the scaled difference to the first phase to generate a refined first phase; and
code for scaling the refined first phase to generate the estimated CFO.

21. The non-transitory computer readable storage medium of claim 20, wherein code for scaling the first phase comprises code for magnifying the first phase wherein code for scaling the difference comprises code for shrinking the difference.

22. The non-transitory computer readable storage medium of claim 21, wherein the second time-lag is four times the first time-lag, the magnifying is by a factor of four, and the shrinking is by a factor of four.

23. The non-transitory computer readable storage medium of claim 21, further comprising code for combining the refined first phase with a third phase generated with a third time-lag, to generate a combined CFO estimate.

24. The non-transitory computer readable storage medium of claim 23, wherein the third time-lag is sixteen times the first time-lag and the second time-lag is four times the first time-lag.
